(19) United States
(12) Patent Application Publication
(10) Pub. No.: US 2023/0349148 A1
(43) Pub. Date: Nov. 2, 2023

(54) Printed Wall Stabilizing Method and Assembly

(71) Applicant: Derek Ray Droge, Chancellor, SD (US)

(72) Inventor: Derek Ray Droge, Chancellor, SD (US)

(21) Appl. No.: 17/731,972

(22) Filed: Apr. 28, 2022

(51) Int. Cl. E04B 1/41; B28B 1/00; E04G 21/12

(52) U.S. Cl. CPC E04B 1/4185; B28B 1/001; E04G 21/12; B33Y 40/00

(57) ABSTRACT

A printed wall stabilizing assembly includes an elongated member having a first end and a second end. The elongated member has a first bend and a second bend therein such that the elongated member is generally U-shaped and defines a bracket. A first arm is defined from the first bend to the first end and a second arm is defined between the second bend and the second end. A central section is defined extending between the first and second arms. The first and second arms lie a same plane as the central section. The elongated member is comprised of a material is resistant to the corrosive effects of water and has low thermal conductivity. The central section positioned in a first wall of a pair of walls such that the first and second arms extend into a second wall of the pair of walls.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (F) STATEMENT REGARDING PRIOR DISCLOSURES BY THE INVENTOR OR JOINT INVENTOR

Not Applicable

### (G) BACKGROUND OF THE INVENTION

### Field of the Invention

The disclosure relates to wall stabilizing device and more particularly pertains to a new wall stabilizing device for used for three-dimensional (3D) printing of dwelling walls. While 3D printing originated as a means for creating small objects, typically out of plastics, by the deposition of material by extrusion onto a plate, it has evolved such that the walls of entire buildings can now be created using a similar technique. For example, an extruder may be mounted on a frame and automatically moved back and forth over an area while depositing a cement or cement like substance as an elongated row. Subsequent rows are thereafter deposited on top of each other to form a vertical wall. The walls of these structures are typically created in pairs so that a first wall and second wall are positioned adjacent to each other. Thereafter, an interior space of between about 3 inches and 12 inches separates the first and second walls. This interior space is akin to the space between outer and inner layers of plywood, sheetrock, or other walling materials that are typically secured on opposite sides of wooden or metal framing. The interior space is utilized for passage of conduits including water lines, heating, ventilation and air conditioning ducting, electrical cordate, communication network cordage, and the like. Additionally, insulation is placed in the interior space for dwelling thermal and sound insulating purposes.

In order to ensure that the first and second walls are stable while curing and furthermore to maintain a constant distance between the first and second walls, varying types of framework are added to the first and second walls to bind them together. The current disclosure teaches a bracket which extends between and engages the first and second walls. The bracket is comprised of a non-metallic, non-corrosive material which, as one benefit, will not easily corrode in the presence of water in either its liquid or gaseous phase. This will ensure that as the material used for the construction of the dwelling wall cures, the bracket will not begin to corrode as would steel due to the moisture in the dwelling wall material and in the surrounding air. The bracket will also have thermally non-conductive characteristics to prevent condensation formation on the bracket. Such a structure will increase the lifespan of the dwelling wall as well as be economical to produce and install. Moreover, the bracket has a relatively small cross-section which will utilize very little area of the interior space and can be staggered in placement such that conduits can be run easily through the interior space and insulation will freely flow between the first and second walls to avoid formation of air pockets having little or no insulation.

### Description of Related Art Including Information Disclosed Under 37 CFR 1.97 and 1.98.

The prior art relates to wall stabilizing devices and methods that either are bulky or made of materials that will corrode over time. These stabilizing devices may include any structural connection and can also be “printed” in the same manner that the first and second walls are created. However, printed structural supports have the disadvantage of not allowing easy movement of conduits since gaps cannot easily be formed within the interior space of a printed dwelling wall. Thus, the movement of conduits and insulation would be extremely difficult. Other stabilizing devices include scaffolding type frameworks placed within the interior space. While such frameworks do stabilize the first and second walls, they include multiple projections which interfere with conduit placement while also inhibiting the flow of insulation throughout the interior space. These types of frameworks are also comprised of metallic materials which will more readily corrode and thereafter degrade in a quickened space of time. Finally, the prior art stabilizing devices and methods tend to include structures making the adding of conduit after the formation of the dwelling wall nearly impossible.

### (H) BRIEF SUMMARY OF THE INVENTION

An embodiment of the disclosure meets the needs presented above by generally comprising an elongated member having a first end and a second end. The elongated member has a first bend and a second bend therein such that the elongated member is generally U-shaped and defines a bracket. A first arm is defined from the first bend to the first end and a second arm is defined between the second bend and the second end. A central section is defined extending between the first and second arms. The first and second arms lie a same plane as the central section. The elongated member is comprised of a material is resistant to the corrosive effects of water and has low thermal conductivity. The central section is configured to be positioned in the first wall of a pair of walls such that the first and second arms extend into the second wall of the pair of walls.

In another embodiment is disclosed a method including forming a lower layer of a first wall and a second wall, wherein the first and second walls are spaced from each other. A bracket, having a U-shaped configuration, is positioned on the lower layer of the first wall and the second wall such that a central section of the bracket is positioned on the first wall, and a first arm and a second arm of the bracket traverse a space between the first and second walls and are positioned on the second wall. The bracket is comprised of a material is resistant to the corrosive effects of water and has low thermal conductivity.

The material is a plastic material. At least one upper layer is formed on the lower layer of the first and second walls such that the bracket is positioned between the upper and lower layers.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### I BRIEF DESCRIPTION OF SEVERAL VIEWS OF THE DRAWINGS

The disclosure will be better understood and objects other than those set forth above will become apparent when consideration is given to the following detailed description thereof. Such description makes reference to the annexed drawings wherein:

FIG. 1 is a top isometric view of a printed wall stabilizing method and assembly according to an embodiment of the disclosure.

FIG. 2 is a top view of an embodiment of the disclosure.

FIG. 3 is a side cross-sectional view of an embodiment of the disclosure.

FIG. 4 is a bottom view of an embodiment of the disclosure.

FIG. 5 is a top isometric view of an embodiment of the disclosure.

FIG. 6 is a top isometric view of an embodiment of the disclosure.

FIG. 7 is a top-isometric view of an embodiment of the disclosure.

FIG. 8 is a cross-sectional view of an embodiment of the disclosure taken along line 8-8 of FIG. 1.

### (J) DETAILED DESCRIPTION OF THE INVENTION

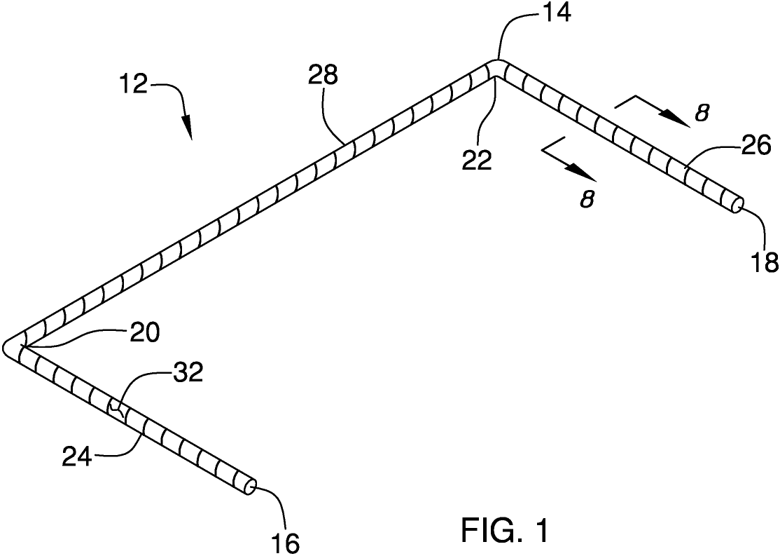

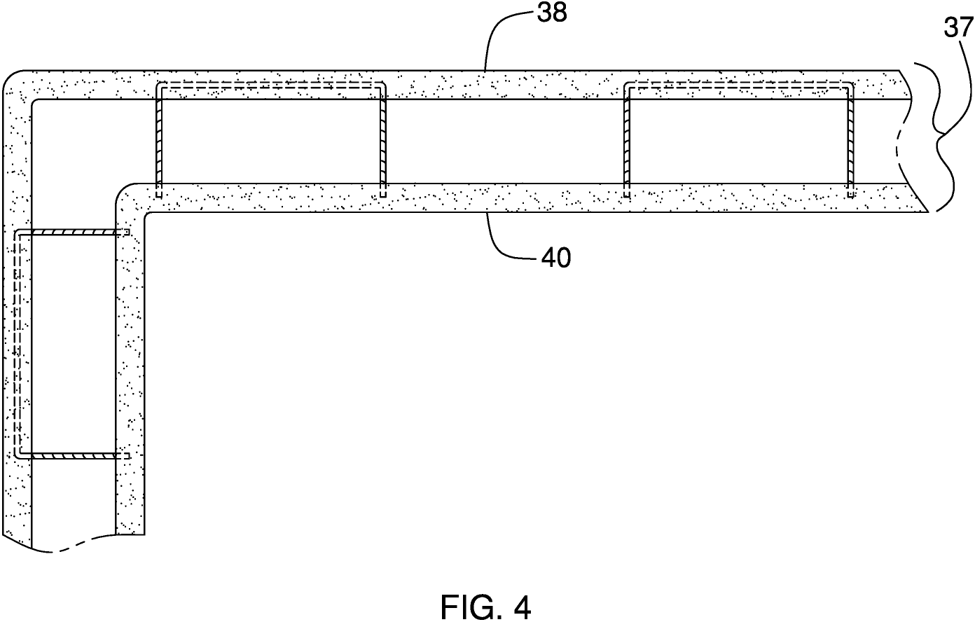

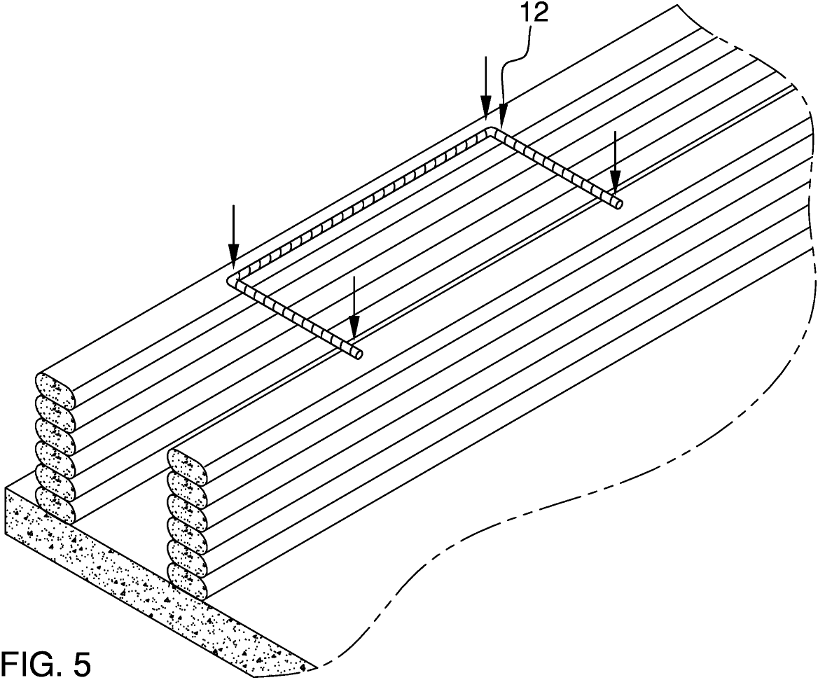

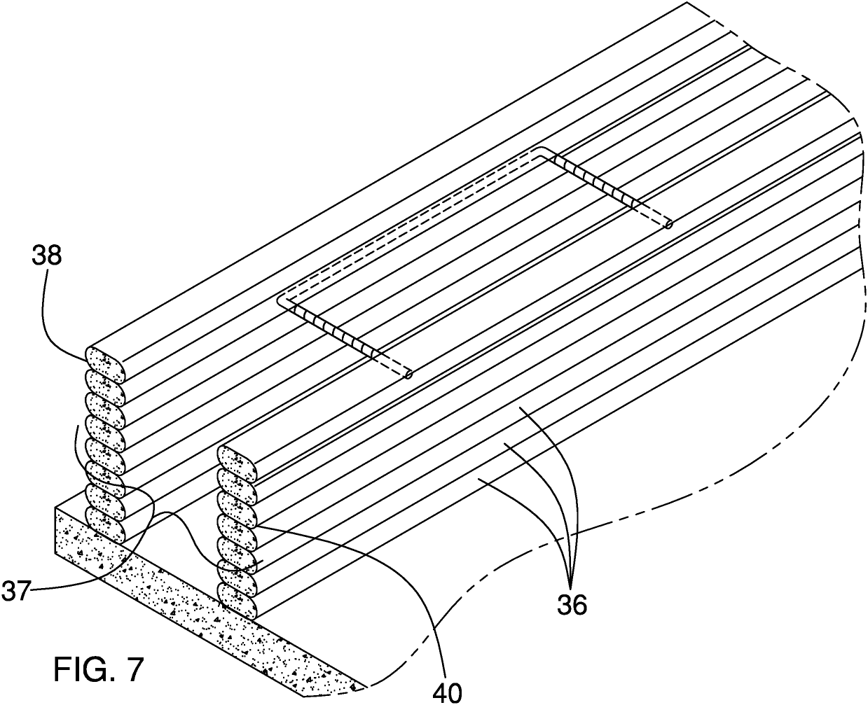

With reference now to the drawings, and in particular to FIGS. 1 through 8 thereof, a new wall stabilizing device embodying the principles and concepts of an embodiment of the disclosure and generally designated by the reference numeral 10 will be described.

As best illustrated in FIGS. 1 through 8, the printed wall stabilizing method and assembly 10 generally comprises an elongated member 14 having a first end 16 and a second end 18. The elongated member 14 has a first bend 20 and a second bend 22 therein such that the elongated member 14 is generally U-shaped and defines a bracket 12. Generally, a first arm 24 is defined from the first bend 20 to the first end 16, a second arm 26 is defined between the second bend 22 and the second end 18, and a central section 28 is defined between the first 24 and second 26 arms. Typically, the first 24 and second 26 arms lie a same plane as the central section 28.

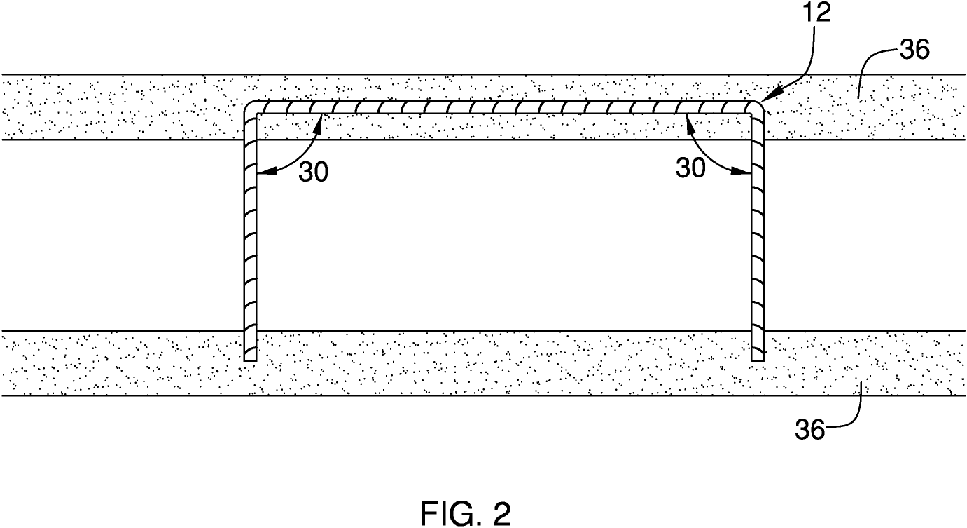

In most embodiments, the first 20 and second 22 bends each form an angle 30 from at least 60° to at most 120°. More typically this angle 30 is between 75° and 105° and most often will be within 5° of an 90° angle. As can be seen in FIG. 2, the angle 30 for the first 20 and second 22 bends are right angles equal to 90°. It should be understood that the first 20 and second 22 bends themselves may be formed as an arcuate bend or may be formed by the intersection of two straight edges. Thus, depending on the mode of manufacture of the elongated member 14, the first 20 and second 22 bends may be gradual arcuate bends or may be precise angles.

The central section 28 has a length form the first bend 20 to the second bend 22 between 4.0 inches and 18.0 inches and each of the first 24 and second 26 arms has a length is between 4.0 inches and 18.0 inches. The lengths of the central section 28, first arm 24, and second arm 26 may vary depending on their specific usage as will become apparent from the below. The elongated member 14 typically will have a width between .25 inches and 2.0 inches. Again, the width may vary depending on the types of walls 32 the assembly 10 is being used with and the load to be supported by the assembly 10. In most embodiments, the central section 28, the first arm 24, and the second arm 26 are each linear.

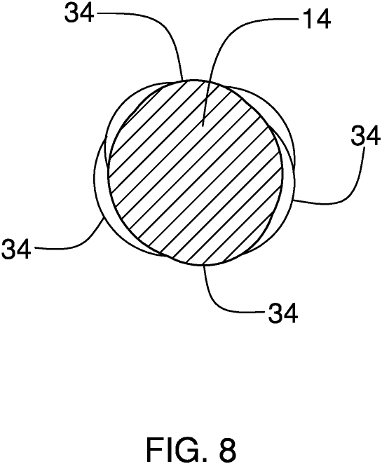

The elongated member 14 has an outer surface 32 which may include protrusions or raised areas 34 as shown in FIG. 8 configured for engaging wall material. The raised areas 34 may be formed in any conventional manner. These may include random detents, threading, or a knurled pattern, for example. The raised areas 34 ensure that the assembly 10 comprises a surface that can be easily gripped by the surrounding environment.

The elongated member 14 is comprised of a material is resistant to the corrosive effects of water and has low thermal conductivity. Generally, the material will comprise a plastic material such as a synthetic polymer and will have a metal content of less than 5% by weight and more ideally will have metal content by from 0% to 2%. Particularly well-suited materials include glass fiber reinforced polymer (also known as glass fiber reinforced plastic or GFRP), fiber reinforced polymer, vinyl ester resins, and fiberglass. Other plastic materials may be utilized which are rigid and resist shearing and elongation. The material used will most often have a tensile strength measured per ASTM D7205-06 greater than 500 MPa and a bending strength measured per ASTM D790 being greater than 500 MPa.

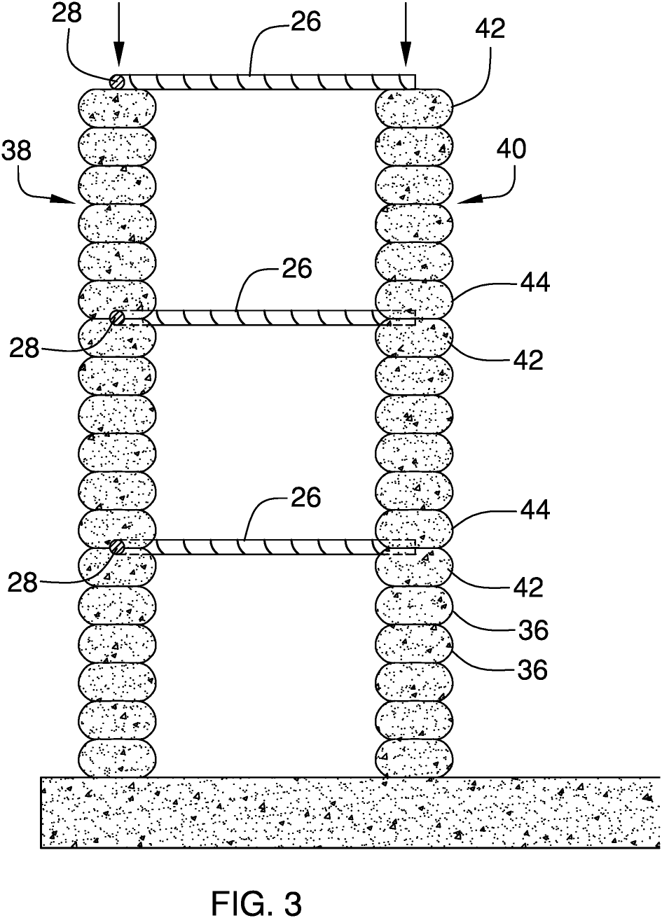

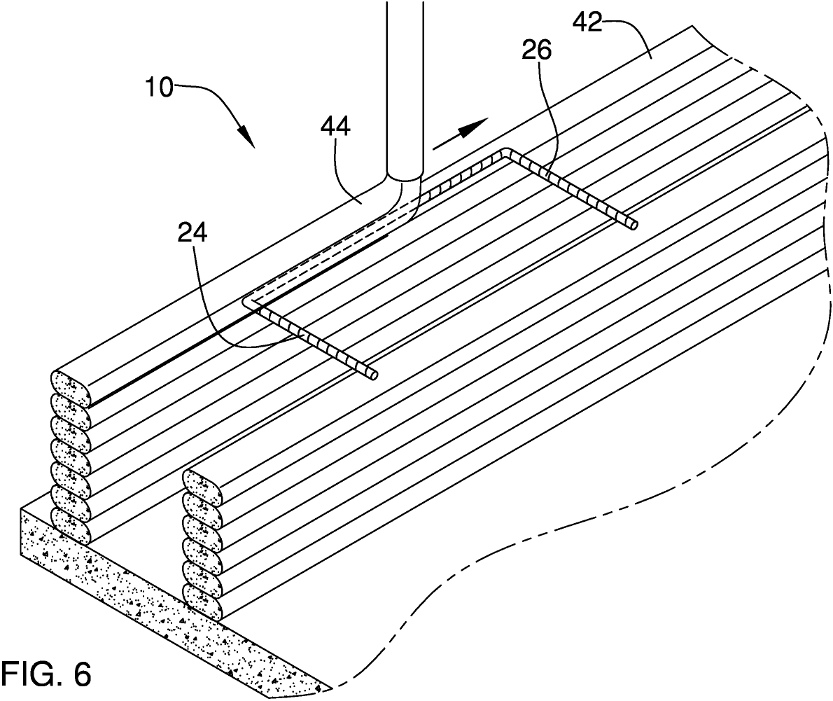

In use, a wall printing assembly typically creates the wall 30 in layers of material 36 and simultaneously creates a first wall 38 and a second wall 40, adjacent to each other, which together form a dwelling wall, i.e. wall 30. When the layers 36 of the first 38 and second 40 walls are created, the bracket 12 can be positioned on one layer 36, such that it traverses a space 42 between the first 38 and second 40 walls. The central section 28 is placed on the first wall 38 and the first 24 and second 26 arms extend to the second wall 40. The bracket 12 may be embedded into the layer 36 if desired. For explanatory purposes as shown in FIG. 3, for each bracket 12 this is defined as the lower layer 42. An upper layer 44 is then deposited over the lower layer 42 as shown in FIG. 6 to sandwich the bracket 12 between the upper 44 and lower 42 layers. Thus, the first 24 and second 26 arms extend out of the first wall 38 and into the second wall 40 to stabilize the first 38 and second 40 walls relative to each other. Additional layers 36 are added, and brackets 12 are positioned between layers 36 as needed since a bracket 12 will not be required for each layer 36.

The brackets 12 allow for conduits, used for running water, circulated air, and electricity, to be easily positioned and run between the first 38 and second 40 walls. The material of which the brackets 12 are made resists corrosion from water and is not subject generally to electrical or magnetic conduction and will further not expand or contract in any meaningful manner due to temperature fluctuations. The relatively narrow profile of the brackets 12 additionally allows insulation to be blown between the first 38 and second 40 walls without concern of air pockets forming due to interference of insulation movement caused by the brackets 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A three-dimensional printed wall stabilizing assembly configured to retain a pair of printed walls in static relationship with respect to each other, the assembly comprising:
an elongated member having a first end and a second end, the elongated member having a first bend and a second bend therein such that the elongated member is generally U-shaped and defines a bracket, a first arm is defined from the first bend to the first end, a second arm is defined between the second bend and the second end, and a central section is defined between the first and second arms, the first and second arms lying a same plane as the central section;
the elongated member being comprised of a material being resistant to the corrosive effects of water and having low thermal conductivity; and
wherein the central section is configured to be positioned in the first wall of a pair of walls such that the first and second arms extend into the second wall of the pair of walls.

2. The three-dimensional printed wall stabilizing assembly according to claim 1, wherein of the first and second bends form an angle from at least 60° to at most 120°.

3. The three-dimensional printed wall stabilizing assembly according to claim 1, wherein the central section has a length form the first bend to the second bend between 4.0 inches and 18.0 inches.

4. The three-dimensional printed wall stabilizing assembly according to claim 3, wherein each of the first and second arms has a length being between 4.0 inches and 18.0 inches.

5. The three-dimensional printed wall stabilizing assembly according to claim 4, wherein the elongated member has a width between .25 inches and 2.0 inches.

6. The three-dimensional printed wall stabilizing assembly according to claim 1, wherein the central section is linear.

7. The three-dimensional printed wall stabilizing assembly according to claim 1, wherein each of the first and second arms each is linear.

8. The three-dimensional printed wall stabilizing assembly according to claim 1, wherein the elongated member has an outer surface including raised areas configured for engaging wall material.

9. The three-dimensional printed wall stabilizing assembly according to claim 1, wherein the material comprises a plastic material.

10. The three-dimensional printed wall stabilizing assembly according to claim 1, wherein the plastic material includes glass fiber reinforced polymer, fiber reinforced polymer, vinyl ester resin, and fiberglass.

11. A three-dimensional printed wall stabilizing assembly configured to retain a pair of printed walls in static relationship with respect to each other, the assembly comprising:
an elongated member having a first end and a second end, the elongated member having a first bend and a second bend therein such that the elongated member is generally U-shaped and defines a bracket, a first arm is defined from the first bend to the first end, a second arm is defined between the second bend and the second end, and a central section is defined between the first and second arms, the first and second arms lying a same plane as the central section, the first and second bends each forming an angle from at least 60° to at most 120°, the central section having a length form the first bend to the second bend between 4.0 inches and 18.0 inches, each of the first and second arms having a length being between 4.0 inches and 18.0 inches, the elongated member having a width between .25 inches and 2.0 inches, the central section being linear, the first and second arms each being linear, the elongated member having an outer surface including raised areas configured for engaging wall material;
the elongated member being comprised of a material being resistant to the corrosive effects of water and having low thermal conductivity, the material being a plastic material, the plastic material including glass fiber reinforced polymer, fiber reinforced polymer, vinyl ester resin, and fiberglass; and
wherein the central section is configured to be positioned in the first wall of a pair of walls such that the first and second arms extend into the second wall of the pair of walls.

12. A method of stabilizing a three-dimensional printed wall comprising the steps of:
forming a lower layer of a first wall and a second wall, wherein the first and second walls are spaced from each other;
positioning a bracket having a U-shaped configuration on the lower layer of the first wall and the second wall such that a central section of the bracket is positioned on the first wall, and a first arm and a second arm of the bracket traverse a space between the first and second walls and are positioned on the second wall, the bracket being comprised of a material being resistant to the corrosive effects of water and having low thermal conductivity, the
material being a plastic material; and forming at least one upper layer on the lower layer of the first and second walls
such that the bracket is positioned between the upper and lower layers.
